(19) United States
(12) Patent Application Publication
(10) Pub. No.: US 2011/0106494 A1
(43) Pub. Date: May 5, 2011

(54) Method and Device for Counting Elapsed Real Time

(76) Inventor: Mark B. Hanson, Niles, MI (US)

(21) Appl. No.: 12/841,227

(22) Filed: Jul. 22, 2010

Related U.S. Application Data
(60) Provisional application No. 61/273,168, filed on Jul. 31, 2009.

(51) Int. Cl. G04F 10/00

(52) U.S. Cl. 702/178

(57) ABSTRACT

A method for counting elapsed real time using a counter wherein, in one embodiment, the length of the counter is a sixteen bit number which, in one embodiment, has been divided into six ranges of logarithmic numbers which each have been assigned a different real time value. A recorded logarithmic number is converted into the elapsed real time to be counted by converting the logarithmic numbers in each of the ranges preceding the recorded logarithmic number into a real time value and then adding up all of the real time values to arrive at the elapsed real time.

### CROSS-REFERENCE TO RELATED AND CO-PENDING APPLICATIONS

This application claims the benefit of the filing date of U.S. Provisional Patent Application Ser. No. 61/273,168 filed on Jul. 31, 2009 and entitled, “Method and Device for Counting Elapsed Real Time”, the entire disclosure of which is explicitly incorporated herein by reference as are all references cited therein.

### FIELD OF THE INVENTION

This invention relates to a method and device for counting elapsed real time.

### BACKGROUND OF THE INVENTION

Many devices incorporate counters designed to measure variables such as, for example, elapsed real time of operation or, for certain devices and/or applications, elapsed real time to failure of a device.

In devices or applications where the elapsed real time to failure is short (i.e., seconds or minutes), a fine or precise resolution or measurement of elapsed real time in seconds or minutes is typically preferred. However, in devices or applications where the elapsed real time to failure is large (i.e., hours or days), a fine or precise resolution or measurement in seconds or minutes is typically not necessary or required.

In certain applications, it is desirable to be able to record time on a sliding scale, maintaining high precision for short intervals, but reducing precision for longer intervals. One typical application is engine run time, where short term tests require high precision in determining when a failure occurred, while long term testing (weeks or months) may require the same counter to be able to report longer times-to-failure.

Currently available counters, however, are capable of measuring either short periods of elapsed real time with higher/greater precision or longer periods of elapsed real time with lower/less precision, but not both simultaneously.

### SUMMARY OF THE INVENTION

The present invention is directed to a sixteen (16) bit based counter and method of simultaneously measuring either short periods with higher/greater precision or longer periods with lower/less precision without overflowing.

The present invention is specifically directed to a method and device for counting elapsed real time using a counter wherein, in one embodiment, the length of the counter is a sixteen-bit number which has been divided into six ranges of logarithmic numbers where each of the ranges has been assigned a different real time value. A recorded logarithmic number corresponding to the elapsed real time to be counted or measured is converted into the elapsed real time to be counted or measured by converting the logarithmic numbers in each of the ranges preceding the recorded logarithmic number into a real time value and then adding up all of the real time values to arrive at the elapsed real time to be counted.

In one embodiment, the method of the present invention comprises the steps of dividing the numbers in each of the six ranges and also assigning a different real time measurement value to each of the six ranges as follows: 0-10,000 (seconds); 10,001-15,000 (seconds×10); 15,001-24,000 (minutes); 24,001-29,000 (minutes×10); 29,001-52,000 (hours); and 52,001-65,535 (days). Other example embodiments are also provided.

Other advantages and features of the present invention will be more readily apparent from the following detailed description of the method and device and the accompanying claims.

### DETAILED DESCRIPTION OF THE INVENTION

The pseudo-logarithmic method and device of elapsed real time counting in accordance with the principles of the invention initially comprises the step of providing a counter configured with a predetermined number of bits. In accordance with one embodiment of the invention, the counter is configured with a sixteen (16) bit logarithmic number which ranges between 0 and 65,535 and is divided into a plurality of selected logarithmic number ranges such as, for example, the ranges (1) through (6) identified in Table 1 below:

TABLE 1

| RANGE | LOGARITHMIC NUMBER |
|---|---|
| 1) | 0-10,000 |
| 2) | 10,001-15,000 |
| 3) | 15,001-24,000 |
| 4) | 24,001-29,000 |
| 5) | 29,001-52,000 |
| 6) | 52,001-65,535 |

The next step in the method includes the step of assigning a different real time interval or value such as, for example, seconds, multiples of seconds, minutes, multiples of minutes, hours, and days to each of the plurality of selected logarithmic number ranges such that, below a certain logarithmic number, a single least-significant bit represents one time interval or value such as, for example, seconds; while, at or above a certain logarithmic number, the bit represents a larger real time interval or value such as, for example, seconds×10 as shown in Table 2 below:

TABLE 2

| | | REAL TIME |
|---|---|---|
| RANGE | LOGARITHMIC NUMBER | INTERVAL/VALUE |
| 1) | 0-10,000 | Seconds |
| 2) | 10,001-15,000 | Seconds × 10 |
| 3) | 15,001-24,000 | Minutes |
| 4) | 24,001-29,000 | Minutes × 10 |
| 5) | 29,001-52,000 | Hours |
| 6) | 52,001-65,535 | Days |

Further, in accordance with the present invention, the overlaps in the logarithmic number ranges identified in Tables 1 and 2 above are selected such that there is not a significant loss of precision when moving from one real time interval to the next successive real time interval such as, for example, when moving from minutes to minutes×10.

Still further, in accordance with the present invention, each of the number ranges are preferably broken at natural breakpoints such that the contribution of a small precision component to the final elapsed real time value can be easily calculated and the sum of all of the lower logarithmic number ranges is an even multiple of the higher range.

For example, the particular breakdown of the logarithmic number ranges identified in Tables 1 and 2 above were chosen because the sum of all of the logarithmic number ranges below, for example, logarithmic number range (4) represents 1,000 counts in the next higher logarithmic number range (5).

Sample conversions of a recorded log_time/number to elapsed real time value for six (6) specific sample recorded logarithmic numbers are shown in Table 3 below:

TABLE 3

| Log _{—} | | Elapsed | |
|---|---|---|---|
| Time/Number | Conversion | Real Time | |
| 10,001 | 10,000 sec. + (1 × 10 sec.) = | 10,010 | sec. |
| 15,001 | 10,000 sec. + (5,000 × 10 sec.) + | 1,001 | min. |
| | (1 × 1 min.) = 60,000 sec. + 1 min. = | | |
| 24,001 | 1,000 min. + (9,000 × 1 min.) + | 10,010 | min. |
| | (1 × 10 min.) = | | |
| 29,001 | 10,000 min. + (5,000 × 10 min.) + | 1,001 | hr. |
| | 1 hr. = 60,000 min. + 1 hour = | | |
| 52,001 | 1,000 hr. + (23,000 × 1 hr.) + 1 day = | 1,001 | days |
| | 24,000 hr. + 1 day = | | |
| 65,535 | 1,000 days + 13,535 days = | 39.8 | years |
| | 14,535 days = | | |

Thus, as shown in Table 3 above, the method includes the steps of first adding up the logarithmic numbers in each logarithmic number range between zero and the logarithmic number corresponding to the elapsed real time to be counted or measured; converting the logarithmic numbers added in each of the logarithmic number ranges into a real time value; and then adding up each of the real time values measured in each of the logarithmic number ranges preceding the recorded logarithmic number corresponding to the elapsed real time to be counted or measured to arrive at the elapsed real time.

Although not disclosed or described herein in any detail, it is understood that the various steps of the method of the present invention are performed by means and use of any suitable or applicable computer hardware and/or computer software. It is also understood that numerous variations and modifications of the method and counter described above may be effected without departing from the spirit and scope of the novel features of the invention.

For example, it is understood that the invention encompasses any other suitable or desired number of ranges of logarithmic numbers or any other suitable or desired real time measurement values such as, for example, the respective seven and eight ranges of logarithmic numbers and corresponding real time measurement values described in Tables 4 and 5 below:

TABLE 4

| | | REAL TIME |
|---|---|---|
| RANGE | LOGARITHMIC NUMBER | INTERVAL/VALUE |
| 1) | 0-10,000 | Microseconds |
| 2) | 10,001-19,000 | Microseconds × 10 |
| 3) | 19,001-28,000 | Microseconds × 100 |
| 4) | 28,001-37,000 | Milliseconds |
| 5) | 37,001-46,000 | Milliseconds × 10 |
| 6) | 46,001-55,000 | Milliseconds × 100 |
| 7) | 55,001-65,535 | Seconds |

TABLE 5

| | | REAL TIME |
|---|---|---|
| RANGE | LOGARITHMIC NUMBER | INTERVAL/VALUE |
| 1) | 0-10,000 | Milliseconds |
| 2) | 10,001-19,000 | Milliseconds × 10 |
| 3) | 19,001-28,000 | Milliseconds × 100 |
| 4) | 28,001-37,000 | Seconds |
| 5) | 37,001-46,000 | Seconds × 10 |
| 6) | 46,001-52,000 | Minutes |
| 7) | 52,001-61,000 | Minutes × 10 |
| 8) | 61,001-65,535 | Hours |

It is thus understood that no limitations with respect to the specific method and counter illustrated and described herein are intended or should be inferred. It is, of course, intended to cover by the appended claims all such modifications as fall within the scope of the claims.

What is claimed is:

1. A method of counting elapsed real time comprising the steps of providing a counter with a sixteen bit number; dividing the sixteen bit number into a plurality of ranges of logarithmic numbers which each have been assigned a different real time value; recording and converting the recorded logarithmic number corresponding to the elapsed real time to be counted by converting the logarithmic numbers in each of the ranges preceding the recorded logarithmic number into respective real time values and then adding up all of the real time values to arrive at the elapsed real time.

2. The method of claim 1, wherein the sixteen bit number is divided into six logarithmic number ranges including the following logarithmic numbers:
1) 0-10,000;
2) 10,000-15,000;
3) 15,001-24,000;
4) 24,001-29,000;
5) 29,001-52,000; and
6) 52,001-65,535.

3. The method of claim 2, wherein the six logarithmic number ranges are respectively assigned the following real time measurement values:
1) seconds;
2) seconds×10;
3) minutes;
4) minutes×10;
5) hours; and
6) days.

4. The method of claim 1, wherein the sixteen bit number is divided into seven logarithmic number ranges including the following logarithmic numbers:
1) 0-10,000;
2) 10,001-19,000;
3) 19,001-28,000;
4) 28,001-37,000;
5) 37,001-46,000;
6) 46,001-55,000; and
7) 55,001-65,535.

5. The method of claim 4, wherein the seven logarithmic number ranges are respectively assigned the following real time measurement values:
1) Microseconds;
2) Microseconds×10;
3) Microseconds×100;
4) Milliseconds;
5) Milliseconds×10;
6) Milliseconds×100; and
7) Seconds.

6. The method of claim 1, wherein the sixteen bit number is divided into eight logarithmic number ranges including the following logarithmic numbers:
1) 0-10,000;
2) 10,001-19,000;
3) 19,001-28,000;
4) 28,001-37,000;
5) 37,001-46,000;
6) 46,001-52,000;
7) 52,001-61,000; and
8) 61,001-65,535.

7. The method of claim 6, wherein the eight logarithmic number ranges are respectively assigned the following real time measurement values:
1) Milliseconds;
2) Milliseconds×10;
3) Milliseconds×100;
4) Seconds;
5) Seconds×10;
6) Minutes;
7) Minutes×10; and
8) Hours.

8. A method of counting elapsed real time comprising the steps of:
providing a counter for counting elapsed real time;
configuring the counter with a predetermined number of bits;
dividing the predetermined number of bits into a plurality of logarithmic number ranges;
recording the logarithmic number corresponding to the elapsed real time to be counted; and
converting the recorded logarithmic number into the elapsed real time to be counted including the steps of:
assigning a different real time measurement value to each of the plurality of logarithmic number ranges;
adding the logarithmic numbers in each of the plurality of logarithmic number ranges between zero and the recorded logarithmic number;
converting the logarithmic number in each of the plurality of logarithmic number ranges between zero and the recorded logarithmic number into a plurality of real time values; and
adding the plurality of real time values together to arrive at the elapsed real time to be counted.

9. The method of claim 8, wherein the counter is configured with a sixteen bit logarithmic number and the sixteen bit logarithmic number is divided into six logarithmic number ranges.

10. The method of claim 9, wherein the six logarithmic number ranges include the following logarithmic numbers:
1) 0-10,000;
2) 10,000-15,000;
3) 15,001-24,000;
4) 24,001-29,000;
5) 29,001-52,000; and
6) 52,001-65,535.

11. The method of claim 10, wherein the six logarithmic number ranges are assigned the following real time measurement values respectively:
1) seconds;
2) seconds×10;
3) minutes;
4) minutes×10;
5) hours; and
6) days.

12. A device for counting elapsed real time comprising:
a counter for counting elapsed real time;
means for configuring the counter with a predetermined number of bits;
means for dividing the predetermined number of bits into a plurality of logarithmic number ranges;
means for recording the logarithmic number corresponding to the elapsed real time to be counted; and
means for converting the recorded logarithmic number into the elapsed real time including:
means for assigning a different real time measurement value to each of the plurality of logarithmic number ranges;
means for adding the logarithmic numbers in each of the plurality of logarithmic number ranges between zero and the recorded logarithmic number corresponding to the elapsed real time to be counted;
means for converting the logarithmic numbers in each of the plurality of logarithmic number ranges between zero and the recorded logarithmic number into a plurality of real time values; and
means for adding the plurality of real time values together to arrive at the elapsed real time.

13. The device of claim 12 wherein the counter is configured with a sixteen bit logarithmic number and the sixteen bit logarithmic number is divided into six logarithmic number ranges.

14. The device of claim 13, wherein the six logarithmic number ranges include the following logarithmic numbers:
1) 0-10,000;
2) 10,000-15,000;
3) 15,001-24,000;
4) 24,001-29,000;
5) 29,001-52,000; and
6) 52,001-65,535.

15. The device of claim 14, wherein the six logarithmic number ranges are assigned the following real time measurement values:
1) seconds;
2) seconds×10;
3) minutes;
4) minutes×10;
5) hours; and
6) days.
